(19) United States
(12) Patent Application Publication
(10) Pub. No.: US 2006/0150179 A1
(43) Pub. Date: Jul. 6, 2006

(54) System for, method of registering a connection, computer readable medium and robot appliance

(75) Inventor: Albertus Josephus Nicolaas Van Breemen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/545,639

(22) PCT Filed: Feb. 9, 2004
(86) PCT No.: PCT/IB04/50089

§ 371 Date: Aug. 16, 2005

(30) Foreign Application Priority Data
Feb. 20, 2003 (EP) 03100398.1

(51) Int. Cl. G06F 9/44

(52) U.S. Cl. 717/170

(57) ABSTRACT

The present invention presents an improved apparatus and method for monitoring a material processing system, wherein the material processing system includes a processing tool, a number of RF-responsive electrical sensors coupled to the processing tool to generate and transmit electrical data, and a sensor interface assembly (SIA) configured to receive the electrical data from the plurality of RF-responsive electrical sensors.

The invention relates to a system for registering a connection between a first software module and a second software module.

The invention further relates to a method of registering a connection between a first software module and a second software module.

The invention further relates to a computer readable medium having stored thereon instructions for causing one or more processing units to perform such a method.

The invention further relates to a robot appliance comprising such a system.

An embodiment of such a system and method is disclosed in EP 09 407 47. Here, it is disclosed that classes of a software system can be added, changed or removed during the program run, by means of a system manager. Hereto, information about subsystems in modules in a modular computer system is included. A class, is a software structure containing one or more attributes and methods that can be used to manipulate these attributes. A subsystem is an instance of a class, which provides a well-defined functionality. Other subsystems may use the interfaces provided by the subsystem in order to use its functionality. A module is a software entity containing one or more subsystems. A module is a dynamically linkable entity. Modules are used internally by the system manager. When a module is downloaded, the system manager calls the module to get information about what subsystems the module contains. When a subsystem is needed, a request is made to the system manager to find the location of the desired subsystem. This system manager finds the module containing the subsystem, orders the module to start the subsystem and returns the location of the requested subsystem. Then the subsystem can be used directly as long as required. The system manager is not needed until another subsystem is to be found. However, if a subsystem is not present upon request, the system manager cannot provide the location of the requested subsystem and thus cannot provide access to the interfaces of the requested subsystem.

It is an object of the invention to provide a system according to the opening paragraph that registers a connection between two software modules in an improved way. To achieve this object, the first software module of the system comprises first port means and the second software module of the system comprises second port means; the first port means is being conceived to connect to the second port means and the second port means is being conceived to connect to the first port means; the first port means comprises registration means conceived to register the second port means as a port to which to connect to; and the second software module comprises notification means conceived to notify the first port means of a change of an availability of the second port means as a port to which to connect to.

The software modules are building blocks used to implement separate pieces of functionality. For example, a software module can implement a functionality such as sensors, actuators, vision algorithms, control behaviors, state estimators, etc. A software module can be started as a separate executable in an operating system. A software module has input and/or output ports to share data and they contain an algorithm to process the data. A port from one module can be connected to another port from another module, thereby creating a connection between the two modules. A port from one module can be connected to different ports of different modules. By registering within each port to which port it can be connected, the ports themselves have the knowledge to which ports they can be connected. Therefore, the ports themselves can be notified about a change in the availability of a port to which they can be connected. Then the ports can take appropriate action based upon the contents of the notification message.

An embodiment of the system according to the invention is described in claim 2. By registering also the ports to which a connection is established, the software module can keep track of the ports to which a connection is expected and the ports to which a connection is established. Therefore, the software module has the knowledge if all its connections have been established yet.

A further embodiment of the system according to the invention is described in claim 3. By including information about a creation of a port to which a connection is expected, the notified port can take appropriate actions, like creating the connection to the created port. Furthermore, by including information about a destruction of a port to which a connection is established, the notified port can take appropriate actions for this event. For example, the notified port can close the connection and register the destructed port to the registration of ports to which to connect to. Furthermore, it can request the software module, which comprises the destructed port, to be added to this software module's registration as a port to be notified in the case that the destructed port is created again.

It is a further object of the invention to provide a method according to the opening paragraph that registers a connection between two software modules in an improved way. To achieve this object, the first software module of the method comprises first port means and the second software module of the method comprises second port means; the first port means being conceived to connect to the second port means and the second port means being conceived to connect to the first port means; and the method comprises registering, by the first port means, the second port means as a port to which to connect to; notifying, by the second software module, the first port means of a change of an availability of the second port means as a port to which to connect to.

Embodiments of the method are described in claims 5 and 6.

These and other aspects of the invention will be apparent from and elucidated with reference to the embodiments described hereinafter as illustrated by the following Figures

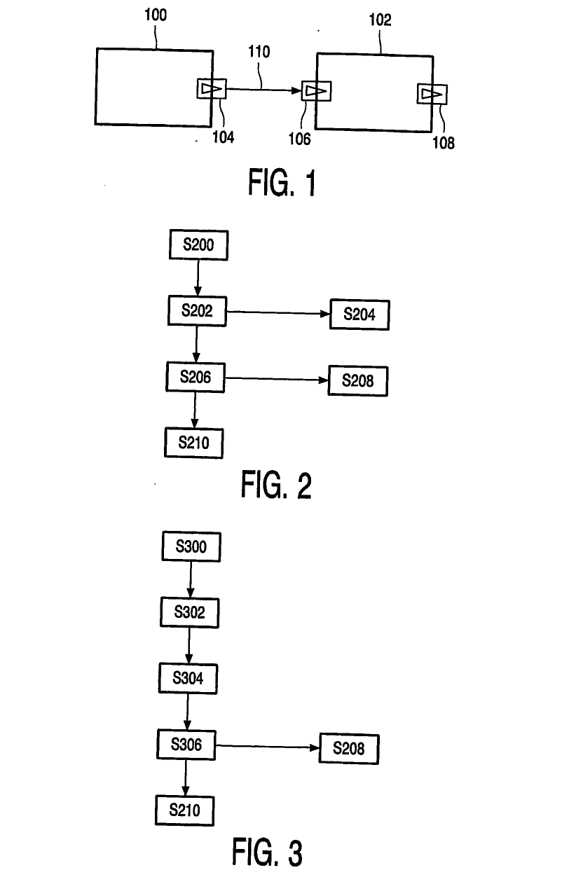

FIG. 1 schematically illustrates a module architecture;

FIG. 2 illustrates method steps of a registration of a software module;

FIG. 3 illustrates method steps of the creation of a module;

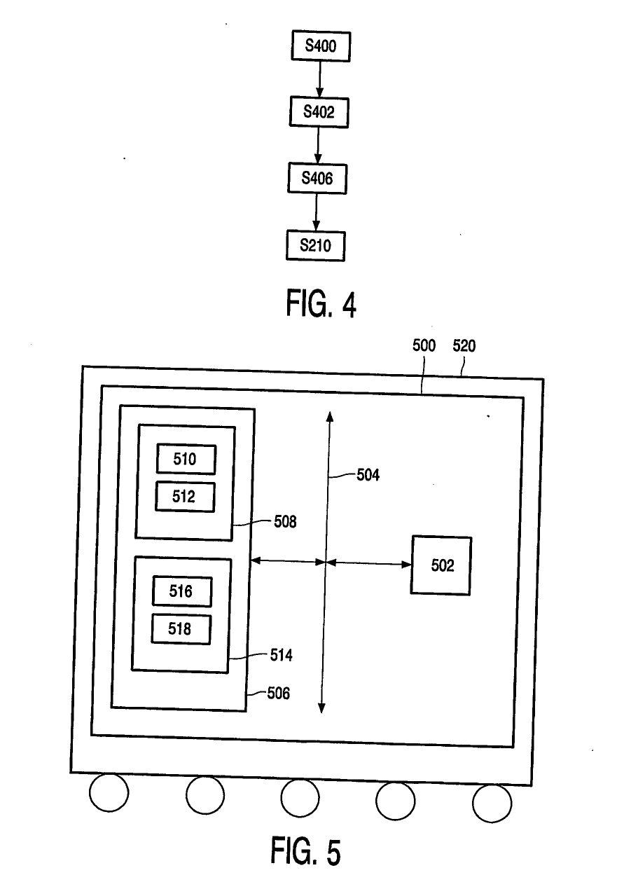

FIG. 4 illustrates method steps of the creation of a connection port;

FIG. 5 illustrates the main parts of the system according to the invention in a schematic way.

Modules are computer readable code that together form building blocks used to implement separate pieces of functionality. For example, modules can implement sensors, actuators, vision algorithms, control behavior, state estimators, a robot application etc. A module is an independent software process that operates asynchronously with respect to other modules within, for example, a robot application. The resources needed by the module, such as processor time and memory, are provided by the operating system. A module is started as a separate executable in the operating system. Furthermore, modules can be implemented independently from other modules.

FIG. 1 schematically illustrates a module architecture. Module 100 comprises an output port 104 and module 102 comprises an input port 106 and an output port 108. The output port 104 of module 100 is connected to the input port 106 of module 102 through connection 110. An input and an output port that are connected to each other share data. The module contains an algorithm to process this data. Ports can be connected to each other at runtime if the attributes of the ports match. A port has the following attributes: port type, data type, buffer type, and trigger type.

port type: there are three different types of ports. The first type are input ports. These ports are used to read data from other modules. The second type are output ports. These ports are used to write data to other modules. Reading and writing from these ports is done asynchronously. That is, if one module writes data to another module, it will not wait until the data has been received, but instead it will continue executing its algorithm. The third type are bi-directional ports, from which one can read and write. This third type allows synchronous communication.

data type: a port supports preferably one data type only. Ports that share the same data type can be connected to each other. Different data types, such as strings, byte, integers and floats, or arrays of these types, etc. can be used within the architecture.

buffer type: because input and output ports operate asynchronously, data can be sent to an output port, without being read yet. Therefore, the buffer type is defined of the port. The first buffer type is the “keep last” buffer, which stores a new data item that has arrived and removes the old data. The second buffer type is the “keep first” buffer, which keeps the first unread data item and removes the newly arrived data items. The third buffer type is the “keep all” buffer, which stores all received and unread data items.

trigger type: there are two types of mechanisms to trigger the transfer of data between ports. The first mechanism is the push mechanism. A push output port directly transfers data to push-input ports connected to it, when the algorithm of the module performs a write action. This generates an external event at the input ports of the connected modules. The second mechanism is the pull mechanism. A pull input port sends a request for new data to the pull output port it is connected to when the algorithm of the modules performs a read action. This generates an external event at the output port of the connected modules. All combinations between push/pull input ports and push/pull output ports are allowed. However, for the combination push input port and pull output port, there's no port that takes the initiative to transfer data.

Ports can also have more (or less) attributes with different types without departing from the concept of the invention.

Each port can be connected to multiple other ports. For instance, if an output port is connected to multiple input ports, then the input ports receive a copy of the data being transferred.

FIG. 2 illustrates method steps of a registration of a software module. As previously described, a module is an independent process. Therefore, in order to connect modules to each other, modules and ports must “find” each other. This is accomplished by giving modules and ports a unique name and using a registry. The registry is a process that maintains a list of the names of all running modules. Within the first step S200, module A is created and sends its name and additional information like its process identification to the registry in order to get registered. Once the module is registered it can search for other modules by name. Module A comprises an output port oA that wants to connect to an input port iB of an other module B. Now, within step S202, module A asks the registry for the process identification of the other module with module name B. In the case that module with name B is not available, the method proceeds to step S204. In the case that the module with name B is available, the method proceeds to step S206.

Within step S204, module A asks the registry to be registered within the notification list of the registry to receive a notification if module B is created. This notification list comprises a table with the names of the modules that need to be notified and the names of the modules for which a creation notification needs to be sent. For example:

| Modules to be notified | Upon creation of |
|---|---|
| Module A | Module B |
| Module X | Module Y |

Other tables or collections are also conceivable, such as a collection per module that needs to be notified or a collection per module that is created.

Within step S206, module A asks module B to connect to input port iB. In the case that input port iB is not available, the method proceeds to step S208. In the case that input port iB is available, the method proceeds to step S210.

Within step S208, module A asks module B to be registered within the notification list of module B to receive a notification upon creation of input port iB. Module B registers the name of module A into its notification list. This notification list comprises the names of all modules that need to be notified in the case that a port is created or removed. The notification list comprises a mapping of module names that need to be notified and ports that are created or removed. The notification list can also be a collection per port of module names that need to be notified. Furthermore, output port oA registers that the connection to input port iB is not yet established.

Within step S210, a connection between output port oA of module A and input port iB of module B is established. Output port oA also comprises a list of port names to which a connection is established and adds input port iB to this “established” list. The input port iB is then removed from the list of output port oA with ports to which a connection could not be established yet. Further, input port iB has its own “established” list and registers output port oA within this list as a port to which a connection is established.

FIG. 3 illustrates method steps of the creation of a module. Within step S300, module A tries to establish a connection to input port iB of module B. However, because module B is not registered yet with the registry, module A is added to the notification list of the registry to be notified if module B is created.

Within step S302, module B is started and registers itself with the registry. The registry registers module B with its module name and its process identification.

Within the next step S304, the registry checks its notification list and notifies module A of the creation of module B.

Within step S306, module A asks module B to connect to input port iB. In the case that input port iB is not available, the method proceeds to step S208 as previously described. In the case that input port iB is available, the method proceeds to step S210 as previously described.

FIG. 4 illustrates method steps of the creation of a connection port. Within step S400, module A tries to establish a connection between output port oA of module A and input port iB of module B. Module A requests the registry for the process identification of module B and module A receives this process identification of the registry. With the use of this identification, module A asks module B to establish a connection to input port iB. However, input port iB is not created yet, and module B adds module A to the notification list of module B to be notified if input port iB is created.

Within step S402, module B creates an input port with name iB. Module B checks its notification list and notified module A that input port iB is created.

Within the next step S404, output port oA of module A requests input port iB of module B to establish a connection.

Within the next step S210 as previously described in performed and a connection between output port oA and input port iB is established.

For registration of destruction of a port or a module, the module and the registry also have a notification list. This “destruction” notification list of a module keeps track of all modules that need to be notified upon destruction of a port of a module. The “destruction” notification list of the registry keeps track of all modules that need to be notified if a module stops executing.

The order in the described embodiments of the method of the current invention is not mandatory, a person skilled in the art may change the order of steps or perform steps concurrently using threading models, multi-processor systems or multiple processes without departing from the concept as intended by the current invention.

FIG. 5 illustrates the main parts of the system according to the invention in a schematic way. The system 500 comprises a microprocessor 502, a software bus 504 and a memory 506. The memory 508 can be a random access memory (RAM). The memory 506 communicates with the microprocessor 502 through software bus 504. The memory 506 comprises computer readable code 508, 510, 512, 514, 516, and 518. The computer readable code 508 is designed as a software module that implements the functionality of a motion sensor. The computer readable code 514 is designed as a software module that implements the functionality of a reaction in response to the sensed motion. The reaction can be movement, an alert etc. The computer readable code 510 is designed to implement the functionality of an output port as previously described. The computer readable code 512 is designed to implement the functionality of registering the ports to which a connection is not established yet. Furthermore, the computer readable code 512 is designed to implement the functionality of registering the ports to which a connection is established. The computer readable code 516 is designed to implement the functionality of an input port as previously described. The computer readable code 518 is designed to implement the functionality of registering the module that must be notified in the case that a port becomes available as previously described. The system 500 is comprised within a robot appliance 520.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. System (500) for registering a connection between a first software module (508) and a second software module (506) wherein:
the first software module (508) comprises first port means (510) and the second software module (506) comprises second port means (516), the first port means (510) being conceived to connect to the second port means (516) and the second port means (516) being conceived to connect to the first port means (510);
the first port means (510) comprises registration means (512) conceived to register the second port means (516) as a port to which to connect to; and
the second software module (506) comprises notification means (518) conceived to notify the first port means (510) of a change of an availability of the second port means (516) as a port to which to connect to.

2. System (500) according to claim 1, wherein the registration means (512) of the first port means (510) is conceived to register the second port means (516) as a port to which the connection is established.

3. System (500) according to claim 1, wherein the availability of the second port indicates a creation of the second port means (516) or a destruction of the second port means (516).

4. Method of registering a connection between a first software module (508) and a second software module (506) wherein
the first software module (508) comprises first port means (510) and the second software module (506) comprises second port means (516), the first port means (510) being conceived to connect to the second port means (516) and the second port means (516) being conceived to connect to the first port means (510); and the method comprises
registering, by the first port means (510), the second port means (516) as a port to which to connect to;
notifying, by the second software module (506), the first port means (510) of a change of an availability of the second port means (516) as a port to which to connect to.

5. Method according to claim 4, the method comprising registering, by the first port means (510), the second port means (516) as a port to which the connection is established.

6. Method according to claim 4, wherein the availability of the second port indicates a creation of the second port or a destruction of the second port.

7. A computer readable medium having stored thereon instructions for causing one or more processing units to perform the method according to claim 4.

8. Robot appliance (520) comprising the system (500) according to claim 1.
